(19) United States
(12) Patent Application Publication
(10) Pub. No.: US 2026/0015503 A1
(43) Pub. Date: Jan. 15, 2026

(54) PLUMBER'S PUTTY

(71) Applicant: OATEY CO., Cleveland, OH (US)

(72) Inventors: Daniel Ward, Eastlake, OH (US); Amrit Parhar, Westlake, OH (US)

(21) Appl. No.: 18/770,139

(22) Filed: Jul. 11, 2024

(51) Int. Cl. C08L 91/06; C08K 3/26; C08K 3/34; C09K 3/10

(52) U.S. Cl. CPC C08L 91/06; C08K 3/26; C08K 3/34; C09K 3/1031; C08K 2003/265; C08K 2003/343; C08K 2201/014; C08L 2205/025; C08L 2205/035; C08L 2207/066; C08L 2207/322; C08L 2207/324; C09K 2200/0239; C09K 2200/0243; C09K 2200/062; C09K 2200/0685

(57) ABSTRACT

Disclosed herein are plumber's putty compositions that avoid staining the surfaces plumbing parts to which they are applied in order to provide a watertight seal, including plastics, such as acrylonitrile butadiene styrene (ABS) plastic, while providing the pliability and softness of traditional putties. Also provided are methods of providing a seal about a plumbing part comprising contacting the plumber's putty composition according to the present disclosure with the plumbing part.

### TECHNICAL FIELD

The present disclosure pertains to plumber's putty compositions.

### BACKGROUND

Plumber's putty is a well-known product used in the plumbing and construction industry. It can be used to seal fixtures such as sinks, tub strainers, and faucets located in the bath or kitchen areas. Plumber's putty maintains a stable consistency and can be used to fill voids during installation. Plumber's putty is generally pliable, tacky to surfaces and resistant to water. The putty should be easily manipulated by hand and can generally be rolled into any shape consistent with the sealing job at hand.

Traditional plumber's putty contains a variety of oils and mineral solvents dispersed in clays and inorganic minerals, such as calcium carbonate. Preferred compositions do not dry out or crack once in place for long periods of time, preferably not during the lifetime of the appliance being installed.

While traditional plumber's putty is useful, it has drawbacks. The oil in the putty can leave a permanent stain or shadow on some porous stones, such as some marbles or granites. The shadow often appears within hours of installation and cannot be removed by cleaning or by physical methods without permanently affecting the surface of the material. This has been a serious problem in the kitchen and bath installation industry especially because materials can be expensive to install or replace.

Plumbers have used a variety of techniques to try to circumvent this problem, but there is an ongoing need for improved compositions, especially those that are compatible with all plumbing materials, including plastics.

### SUMMARY

The present disclosure provides plumber's putty compositions that include a wax component, a plant-derived oil, silicone oil, a tack-reducing filler, and a mineral filler.

Also disclosed herein are methods of making a plumber's putty composition by combining the aforementioned components.

The present disclosure also pertains to methods of providing a seal about a plumbing part comprising contacting a plumber's putty composition according to any preceding claim with the plumbing part.

### DETAILED DESCRIPTION OF ILLUSTRATIVE EMBODIMENTS

The present invention may be understood more readily by reference to the following detailed description taken in connection with the accompanying examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

The disclosures of each patent, patent application, and publication cited or described in this document are hereby incorporated herein by reference, in their entirety.

As employed above and throughout the disclosure, the following terms and abbreviations, unless otherwise indicated, shall be understood to have the following meanings.

In the present disclosure the singular forms “a”, “an”, and “the” include the plural reference, and reference to a particular numerical value includes at least that particular value, unless the context clearly indicates otherwise. Thus, for example, a reference to “a compound” is a reference to one or more of such compounds and equivalents thereof known to those skilled in the art, and so forth. Furthermore, when indicating that a certain chemical moiety “may be” X, Y, or Z, it is not necessarily intended by such usage to exclude other choices for the moiety; for example, a statement to the effect that a moiety “may be alkyl, aryl, or amino” does not necessarily exclude other choices for the moiety, such as halo, aralkyl, and the like.

When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” may refer to a value of 7.2 to 8.8, inclusive; as another example, the phrase “about 8%” may refer to a value of 7.2% to 8.8%, inclusive. Also, when the term “about” precedes a range, it is understood that the term modifies both recited endpoints and all points embraced within the range. For example, the phrase “about 1-10” is understood to mean “about 1 to about 10”, as well as “about x”, wherein x refers to any value between 1 and 10. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” In another example, when a listing of possible choices for a moiety including “talc, kaolin clay, air-floated clay, calcined clay, and aluminum trihydrate” is provided, the recited listing may be construed as including situations whereby any of talc, kaolin clay, air-floated clay, calcined clay, and aluminum trihydrate is negatively excluded; thus, a recitation of “talc, kaolin clay, air-floated clay, calcined clay, and aluminum trihydrate” may be construed as “talc, kaolin clay, air-floated clay, and calcined clay, but not aluminum trihydrate”, or simply “wherein the filler is not aluminum trihydrate”.

A recent improvement to traditional plumber's putty is stain-free plumber's putty, which is intended to diminish or eliminate negative staining effects of traditional plumber's putty. Typically, a stain-free plumber's putty composition comprises one or more plasticizers (e.g., Paraplex G-40), which improves its stain-free properties and provides stretch to the wax. More specifically, the plasticizer replaced some oils (e.g., naphthenic and paraffinic mineral oils) in traditional plumber's putty that were attributable to causing staining.

While the introduction of a plasticizer was effective at limiting the staining properties of traditional plumber's putty, there have been instances in which there has been interaction of the plasticizer with well-known piping materials, such as PVC, CPVC, or ABS plastics. For example, prolonged exposure of some plasticizers to ABS can cause ABS to degrade at an increased rate. This has imposed limitations on certain uses of plasticizers in stain-free plumber's putty.

The present inventors have surprisingly discovered that combining a wax component and a tack-reducing filler results in a plumber's putty composition that possesses stain-free properties and does not cause premature degradation, including when used with plastic components (such as ABS plastic), confers the requisite watertight characteristics, and has a usable consistency.

Whether or not a putty composition causes staining may be tested according to ASTM-D-2203-01 (2023)—Staining of Oil and Resin-Base Caulking Compounds (iteh.ai). In some embodiments of the present putty compositions, “no staining” may mean that the composition does not produce any staining on the surface with which the putty is directly contacted. However, in other embodiments, “no staining” means that there is also no visible staining on the surface of a material that is immediately adjacent to the surface with which the putty is directly contacted. In other words, the non-staining characteristic can reflect the non-migration of oils that would otherwise cause visible staining in surfaces that are immediately adjacent to the surface with which the putty is directly contacted. The distinction between staining of surfaces that directly contact the putty and staining of surfaces adjacent to the direct-contact surface is an important one, because following removal of the putty from a porous material, there may in fact be “staining” on the porous material that the putty was contacting. From a commercial standpoint, although direct-contact staining may not be a concern because the putty directly contacts inconspicuous surfaces, there may be instances in which the inconspicuous direct-contact surfaces are adjacent to very conspicuous surfaces, so staining of adjacent surfaces caused by migration of oils can represent a significant concern. The presently disclosed putty compositions may be characterized as not causing direct-contact surface staining, adjacent surface staining, or both.

Accordingly, provided herein are plumber's putty compositions comprising a wax component in an amount of about 15-25 wt %; a plant-derived oil in an amount of about 4-6 wt %; silicone oil in an amount of about 1-3 wt %; a tack-reducing filler in an amount of about 2-4 wt %; and a mineral filler in an amount of about 65-75 wt %, wherein the weight percentages are expressed in terms of the total weight of the plumber's putty composition. The present putty compositions may omit plasticizers. For example, the putty compositions may omit the plasticizer Paraplex® G-40.

In some embodiments, the wax component includes a single species of wax. In other embodiments, the wax component includes a first wax member and a second wax member. The first and second wax members may respectively be single wax species or combinations of two or more wax species.

The first wax member may be selected to have a higher density than the second wax member. The first wax member may be a polyethylene wax, and an exemplary polyethylene wax is low-density polyethylene wax (LDPE).

The first wax member may be present in the composition in an amount of about 6-10 wt %, based on the total weight of the putty composition. For example, the first wax member may be present in an amount of about 6, 6.25, 6.5, 6.75, 7, 7.25 7.5, 7.75, 8, 8.25, 8.5, 8.75, 9, 9.25, 9.5, 9.75, or 10 wt %, based on the total weight of the putty composition.

The second wax member may be selected to confer a lower melting point and hardness to the wax component relative to the first wax member alone. The second wax member preferably has a lower hardness than the first wax member (e.g., a lower hardness than LDPE) at room temperature. In some embodiments, the second wax member has a lower congealing point than the first wax member (e.g., a lower congealing point than that of LDPE). In some embodiments, the second wax member may have a broader range of carbon chains than the first wax member, more branched carbon chains than the first wax member, or both. The second wax member may include a microcrystalline wax. Alternatively or additionally, the second wax member may include a paraffin wax. In some embodiments, the second wax member may include a petrolatum wax. In further embodiments, the second wax member may be a sealing wax (e.g., a wax that is used to provide a seal between a toilet fixture and a closet flange on the floor, typically commercially available as a wax ring), which can be generally characterized as a paraffin-based wax that is semi-solid at room temperature. In some instances, the sealing wax can represent a combination of microcrystalline wax and slack wax, wherein slack wax may include paraffin and oil originated from petroleum crude oil.

The second wax member may be present in the composition in an amount of about 10-14 wt %, based on the total weight of the putty composition. For example, the second wax member may be present in an amount of about 10, 10.25, 10.5, 10.75, 11, 11.25, 11.5, 11.75, 12, 12.25, 12.5, 12.75, 13, 13.25, 13.5, 13.75, or 14 wt %, based on the total weight of the putty composition.

The plant-derived oil may be any oil that is obtained from a plant. Examples include soybean oil, almond oil, canola oil, coconut oil, corn oil, cottonseed oil, flaxseed oil, linseed oil, olive oil, palm oil, peanut oil, safflower oil, sesame oil, sunflower oil, walnut oil, castor oil, avocado oil, grapeseed oil, hemp oil, pumpkin seed oil, rice bran oil, soybean oil, and combinations thereof. In certain embodiments, the plant-derived oil comprises castor oil or canola oil, such as Z1 castor oil, Z1-Z3 blown castor oil, or Z2 blown canola oil.

The plant-derived oil may be present in the putty composition in an amount of about 4-6 wt %, such as about 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6 wt %, based on the total weight of the putty composition.

The silicone oil is included in the putty composition improves the rheology of the composition and reduces tack. The silicone oil can also reduce stickiness that might otherwise be caused by the wax component. The oil preferably has a relatively high viscosity in order to minimize leaching onto a surface onto which the putty is applied during use. The viscosity of the silicone oil may be about 500-2000 centistokes, such as about 600-1800, 700-1600, 750-1500, 800-1400, 800-1200, or 900-1100 centistokes, such as 500, 600, 700, 800, 900, 1000, 1100, 1200, 1300, 1400, 1500, 1600, 1700, 1800, 1900, or 2000 centistokes.

The silicone oil may be present in the putty composition in an amount of about 1-3 wt %, such as about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 wt %, based on the total weight of the putty composition.

The tack-reducing filler may be any material that has the ability to absorb oil efficiently. For example, the tack-reducing filler can absorb oil more efficiently than a substance like calcium carbonate. The ability to absorb oil is believed to prevent leaching of the oil into the surface onto which the putty is applied during use. The tack-reducing filler should also have the characteristics of reducing tack and hardness of the putty. In some embodiments, the tack-reducing filler includes particles having a lamellar (plate-shaped) configuration, which the inventors have found can also help reduce tackiness when the putty is worked, e.g., with the hands. In some embodiments, the tack-reducing filler comprises talc, kaolin clay, air-floated clay, calcined clay, aluminum trihydrate, or any combination thereof. For example, the tack-reducing filler can include talc, and in some instances the tack-reducing filler includes a combination of talc and a carbonate mineral. In some further embodiments, the tack-reducing filler comprises a combination of talc and a magnesium carbonate component. An exemplary material that includes talc and a carbonate material is Vertal® 202 (available from Magris Talc, Greenwood Village, CO).

The tack-reducing filler may be present in the putty composition in an amount of about 2-4 wt %, such as about 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 wt %, based on the total weight of the putty composition.

The mineral filler may be any be any filler that includes, for example, blocky or round particles, preferably having an average particle size of about 6-22 microns. Particle sizes that are larger than 6 microns can assist in softening the putty by reducing oil absorption by the mineral filler. An exemplary average particle size is about 18 microns. An exemplary mineral filler is calcium carbonate. Additional components can be included, for example, in order to change color or assist with elasticity. Additional components may include limestone, dolomite, feldspar, nepheline syenite, or any combination thereof. When additional components are included, they may be considered as part of the mineral filler. Thus, expressions as to the amount of the mineral filler in the putty composition may take into account any additional components.

The mineral filler may be present in the putty composition in an amount of about 65-75 wt %, such as about 65, 65.5, 66, 66.5, 67, 67.5, 68, 68.5, 69, 69.5, 70, 70.5, 71, 71.5, 72, 72.5, 73, 73.5, 74, 74.5, or 75 wt %, based on the total weight of the putty composition.

In particular embodiments, the plumber's putty composition may be such that the wax component comprises low-density polyethylene wax (LDPE) and a combination of microcrystalline wax and paraffin wax, the plant-derived oil comprises castor oil, the silicone oil has a viscosity of about 800-1200 centistokes, the tack-reducing filler comprises a combination of talc and calcium carbonate, and the mineral filler comprises calcium carbonate. In such embodiments, the LDPE may be present in an amount of 6-10 wt %, preferably about 8 wt %, the combination of microcrystalline wax and paraffin wax may be present in an amount of about 10-14 wt %, preferably about 12 wt %, the castor oil may be Z1 castor oil and may be present in an amount of about 4-6 wt %, preferably 5 wt %, the silicone oil may be present in an amount of about 1-3 wt %, preferably 2 wt %, the calcium carbonate mineral filler may be present in an amount of about 67-73 wt %, preferably about 70 wt %, and the combination of talc and calcium carbonate representing the tack-reducing filler may be present in an amount of about 2-4 wt %, preferably about 3 wt %, wherein such weight percentages are expressed relative to total weight of the plumber's putty composition. In such embodiments, the combination of microcrystalline wax and paraffin wax may be provided in the form of a combination of microcrystalline wax and a slack wax, wherein the combination in certain instances can be represented by a sealing wax. Sealing waxes may include waxes having optimum applications as bowl ring waxes, such as those that are generally available from Hase Petroleum Wax Co. (Arlington Heights, IL), The International Group, Inc. (IGI; Toronto, ON), HollyFrontier (Dallas, TX), or Calumet (Indianapolis, IN).

Also provided herein are methods of providing a seal about a plumbing part comprising contacting a plumber's putty composition according to any embodiment disclosed herein with the plumbing part. The plumbing part may be, for example, a bowl, a frame, a faucet, a drain, a spigot, a strainer, a pipe, or the like. The plumber's putty composition may be contacted with the plumbing part at a joint between the plumbing part and another plumbing component, or between the plumbing part and a surface. The present compositions may be used in any customary manner with respect to conventional plumber's putties, with the added benefit that the present putties can be used in contact with plastic plumbing parts, such as those made with polyvinyl chloride (PVC), chlorinated polyvinyl chloride (CPVC), acrylonitrile butadiene styrene (ABS), high-density polyethylene (HDPE), or cross-linked polyethylene (PEX). In certain embodiments, the plumbing part comprises ABS plastic, and the plumber's putty composition does not cause staining on the plumbing part, and does not cause degradation of the ABS plastic.

The present disclosure also provides methods of making a plumber's putty composition comprising combining the wax component, the plant-derived oil, the silicone oil, the tack-reducing filler, and the mineral filler in order to produce the plumber's putty composition. Each of the wax component, the plant-derived oil, the silicone oil, the tack-reducing filler, and the mineral filler may be in accordance with any of the embodiments disclosed supra in connection with the inventive plumber's putty compositions. The particular manner in which the respective materials are combined (e.g., the order of addition) is not necessarily critical to the formation of the putty compositions. However, in some embodiments, the wax component in a melted form may first be introduced into a vessel, followed by addition of the silicone oil and the plant-derived oil, followed by the filler components. During the synthetic process, the temperature should be maintained such that it remains below the degradation temperature of the wax component. Exemplary temperatures respectively representing an upper limit during the preparation of an inventive composition are 200° F., 195° F., 190° F., 185° F., or 180° F.

### EXAMPLES

The present invention is further defined in the following Examples. It should be understood that these examples, while indicating preferred embodiments of the invention, are given by way of illustration only, and should not be construed as limiting the appended claims. From the above discussion and these examples, one skilled in the art can ascertain the essential characteristics of this invention, and without departing from the spirit and scope thereof, can make various changes and modifications of the invention to adapt it to various usages and conditions.

### Example 1—Plumber's Putty Composition with Dual Wax Component

A plumber's putty composition was prepared using the components and concentrations specified in Table 1, below.

TABLE 1

| Component | Weight Percentage |
|---|---|
| Low-density polyethylene wax | 8 |
| Sealing wax | 12 |
| Silicone oil (Wacker AK 1000) | 2 |
| Z1 blown castor oil | 5 |
| Calcium carbonate | 70 |
| Talc (Vertal ® 202) | 3 |

### Example 2—Reactivity Test (Stress Cracking Test)

The plumber's putty composition produced in Example 1 was applied to ABS plastic in order to determine the compatibility of the composition with the plastic. In particular, the IAPMO PS 36 testing protocol was used, involving wedging a strip of ABS plastic within a holder under stress, microscopically confirming that there are no pre-existing cracks or imperfections on the plastic strip, applying the test material (here, the plumber's putty composition of Example 1) to the top surface of the plastic, and evaluating the integrity of the plastic after 30 days at 90° F. to determine if any cracks are formed. Following the 30 day period, it was determined that the integrity of the ABS plastic strip had not been compromised. For example, no cracking of any type (surface cracking or through-thickness cracking, which would be indicative of a failed test) was observed. These results demonstrated the compatibility of the inventive putty composition with ABS plastic.

### Example 3—Staining Test

The plumber's putty composition produced in Example 1 underwent testing to determine the likelihood that the plumber's putty would cause staining on a porous substrate. In particular, the ASTM D2203 testing protocol was used, involving placing a ¾ inch diameter and ¾ inch high brass ring on ten sheets of dried filter paper. The ring was filled with the test sample, aluminum foil was placed on top of the ring, and then a 300 g weight was placed on top of the aluminum foil. After 72 hours at room temperature, the filter papers were examined for depth of stain and how wide any stain traveled outside the brass ring. With respect to the present sample, the putty composition did not produce any staining beyond the first filter paper, and it did not stain outside the brass fitting.

What is claimed:

1. A plumber's putty composition comprising:
a wax component in an amount of about 15-25 wt %;
a plant-derived oil in an amount of about 4-6 wt %;
silicone oil in an amount of about 1-3 wt %;
a tack-reducing filler in an amount of about 2-4 wt %; and,
a mineral filler in an amount of about 65-75 wt %;
wherein the weight percentages are expressed in terms of the total weight of the plumber's putty composition.

2. The plumber's putty composition according to claim 1 wherein the wax component comprises a first wax member and a second wax member, wherein the first wax member has a higher density than the second wax member, and the second wax member confers a lower melting point and hardness to the wax component relative to the first wax member alone.

3. The plumber's putty composition according to claim 2, wherein the first wax member is a polyethylene wax.

4. The plumber's putty composition according to claim 3, wherein the first wax member is low-density polyethylene wax (LDPE).

5. The plumber's putty composition according to claim 2, wherein the second wax member comprises a microcrystalline wax.

6. The plumber's putty composition according to claim 2, wherein the second wax member comprises a paraffin wax.

7. The plumber's putty composition according to claim 2, wherein the first wax member is present in an amount of about 6-10 wt % and the second wax member is present in an amount of about 10-14 wt %, based on the total weight of the plumber's putty composition.

8. The plumber's putty composition according to claim 1, wherein the plant-derived oil comprises castor oil or canola oil.

9. The plumber's putty composition according to claim 1, wherein the composition does not include a plasticizer.

10. The plumber's putty composition according to claim 1, wherein the tack-reducing filler comprises talc, kaolin clay, air-floated clay, calcined clay, aluminum trihydrate, or any combination thereof.

11. The plumber's putty composition according to claim 1, wherein the tack-reducing filler comprises talc.

12. The plumber's putty composition according to claim 11, wherein the tack-reducing filler further comprises a carbonate mineral.

13. The plumber's putty composition according to claim 1, wherein the mineral filler has an average particle size of about 6 to 22 μm.

14. The plumber's putty composition according to claim 1, wherein the mineral filler comprises a calcium carbonate.

15. The plumber's putty composition according to claim 14, wherein the mineral filler further comprises limestone, dolomite, feldspar, nepheline syenite, or any combination thereof.

16. The plumber's putty composition according to claim 1 wherein
the wax component comprises low-density polyethylene wax (LDPE) and a combination of microcrystalline wax and paraffin wax;
the plant-derived oil comprises castor oil;
the silicone oil has a viscosity of about 800-1200 centistokes;
the tack-reducing filler comprises a combination of talc and calcium carbonate; and,
the mineral filler comprises calcium carbonate.

17. A method of providing a seal about a plumbing part comprising contacting a plumber's putty composition according to claim 1 with the plumbing part.

18. The method according to claim 17, wherein the plumber's putty composition contacts the plumbing part at a joint between the plumbing part and another plumbing component or a surface.

19. The method according to claim 17, wherein the plumbing part comprises acrylonitrile butadiene styrene (ABS) plastic, and wherein the plumber's putty composition does not cause staining on the plumbing part.

20. A method of making the plumber's putty composition according to claim 1, comprising combining the wax component, the plant-derived oil, the silicone oil, the tack-reducing filler, and the mineral filler in order to produce the plumber's putty composition.
